(19) United States
(12) Patent Application Publication
(10) Pub. No.: US 2024/0201524 A1
(43) Pub. Date: Jun. 20, 2024

(54) OPTICAL INTEGRATED CIRCUIT DEVICE AND OPTICAL SYSTEM INCLUDING THE SAME

(71) Applicants: Electronics and Telecommunications Research Institute, Daejeon (KR); KOREA ADVANCED INSTITUTE OF SCIENCE AND TECHNOLOGY, Daejeon (KR)

(72) Inventors: Kiwon Moon, Daejeon (KR); Jung Jin Ju, Daejeon (KR); Hyeon Hwang, Daejeon (KR); Min-Kyo Seo, Daejeon (KR); Hansuek Lee, Daejeon (KR)

(73) Assignees: Electronics and Telecommunications Research Institute, Daejeon (KR); KOREA ADVANCED INSTITUTE OF SCIENCE AND TECHNOLOGY, Daejeon (KR)

(21) Appl. No.: 18/540,415

(22) Filed: Dec. 14, 2023

(30) Foreign Application Priority Data
Dec. 15, 2022 (KR) 10-2022-0176311
Nov. 30, 2023 (KR) 10-2023-0171574

(51) Int. Cl. G02F 1/035; G02F 1/03

(52) U.S. Cl. CPC G02F 1/035; G02F 1/0316; G02F 1/0322; G02F 2203/15

(57) ABSTRACT

Provided is an optical integrated circuit device. The device includes a substrate, a buffer layer provided on the substrate, an optical waveguide layer provided on the buffer layer and including a signal waveguide and a resonant waveguide adjacent to an input terminal and output terminal of the signal waveguide, and a plurality of signal electrodes provided on one side of the resonant waveguide and on the optical waveguide layer of both sides of the signal waveguide.

### CROSS-REFERENCE TO RELATED APPLICATIONS

This U.S. non-provisional patent application claims priority under 35 U.S.C. § 119 of Korean Patent Application No. 10-2022-0176311, filed on Dec. 15, 2022, and No. 10-2023-0171574, filed on Nov. 30, 2023, the entire contents of which are hereby incorporated by reference.

### BACKGROUND

The present disclosure herein relates to an optical system, and more particularly, to a photon storage optical integrated circuit device using a self-interference resonance structure and an optical system including the same.

Quantum information and communication refers to any technical field in which quantum states are generated, controlled, measured, and analyzed in order to apply quantum mechanical characteristics to information and communication technology. The core areas of quantum information and communication are roughly classified into quantum communication, quantum computing, and quantum sensing and measurement, and, in most areas of quantum information and communication technology, a quantum information state is expressed as qubit (quantum bit) that is a quantal extended concept of a bit that is a basic unit of information used in conventional information and communication technology. Unlike a bit, a qubit may simultaneously have information states corresponding to quantum states |0> and |1> on the Bloch sphere, i.e., may be subject to a superposition principle, thus making it possible to develop new technology and system configuration beyond technical limitations of conventional information and communication technology. Therefore, quantum information and communication technology attract great attention as future information and communication technology, and some technologies already have been applied to systems and services.

### SUMMARY

The present disclosure provides an optical integrated circuit device capable of electrically controlling a coupling coefficient at high speed and an optical system including the same.

An embodiment of the inventive concept provides an optical integrated circuit device including: a substrate; a buffer layer provided on the substrate; an optical waveguide layer provided on the buffer layer and including a signal waveguide and a resonant waveguide adjacent to an input terminal and output terminal of the signal waveguide; and a plurality of signal electrodes provided on one side of the resonant waveguide and on the optical waveguide layer of both sides of the signal waveguide.

In an embodiment, the optical waveguide layer may include a lithium niobate.

In an embodiment, the resonant waveguide may include: a main resonant waveguide; and a minor resonant waveguide in the main resonant waveguide.

In an embodiment, the optical integrated circuit device may further include first side resonant electrodes provided on one sides of the main resonant waveguide and the minor resonant waveguide.

In an embodiment, the first side resonant electrodes may include: a first external resonant electrode on an outer periphery of the main resonant waveguide; and a first internal resonant electrode in the minor resonant waveguide.

In an embodiment, the first side resonant electrodes may further include a first middle resonant electrode provided between the first external resonant electrode and the first internal resonant electrode and between the main resonant waveguide and the minor resonant waveguide.

In an embodiment, the optical integrated circuit device may further include second side resonant electrodes provided on other sides of the main resonant waveguide and the minor resonant waveguide.

In an embodiment, the second side resonant electrodes may include: a second external resonant electrode on an outer periphery of the main resonant waveguide; and a second internal resonant electrode in the minor resonant waveguide.

In an embodiment, the second side resonant electrodes may further include a second middle resonant electrode provided between the second external resonant electrode and the second internal resonant electrode and between the main resonant waveguide and the minor resonant waveguide.

In an embodiment, the optical integrated circuit device may further include an input resonant electrode provided adjacent to the input terminal and the resonant waveguide; and an output resonant electrode provided adjacent to the output terminal and the resonant waveguide.

In an embodiment of the inventive concept, an optical system includes: a light source configured to generate light; a photodetector configured to detect the light; and an optical integrated circuit device provided between the light source and the photodetector. In an embodiment, the optical integrated circuit device may include: a substrate; a buffer layer provided on the substrate; an optical waveguide layer provided on the buffer layer and including a signal waveguide and a resonant waveguide adjacent to an input terminal and output terminal of the signal waveguide; and a plurality of signal electrodes provided on one side of the resonant waveguide and on the optical waveguide layer of both sides of the signal waveguide.

In an embodiment, the resonant waveguide may include: a main resonant waveguide; and a minor resonant waveguide smaller the main resonant waveguide.

In an embodiment, the minor resonant waveguide may be arranged outside the main resonant waveguide and provided adjacent to the input terminal and the output terminal.

In an embodiment, the minor resonant waveguide may be shaped like J.

In an embodiment, the main resonant waveguide may be shaped like a disc.

In an embodiment of the inventive concept, an optical integrated circuit device includes: a substrate; a buffer layer provided on the substrate; an optical waveguide layer provided on the buffer layer and including a signal waveguide and a resonant waveguide adjacent to an input terminal and output terminal of the signal waveguide; and a plurality of signal electrodes provided on one side of the resonant waveguide and on the optical waveguide layer of both sides of the signal waveguide. In an embodiment, the resonant waveguide may include: a main resonant waveguide; and a minor resonant waveguide provided outside the main resonant waveguide and smaller than the main resonant waveguide.

In an embodiment, the optical integrated circuit device may further include first side resonant electrodes provided outside and inside the main resonant waveguide adjacent to the signal electrodes.

In an embodiment, the optical integrated circuit device may further include second side resonant electrodes provided outside and inside the minor resonant waveguide adjacent to the input terminal and the output terminal.

In an embodiment, the minor resonant waveguide may be shaped like J.

In an embodiment, the main resonant waveguide may be shaped like a disc.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a plan view illustrating an example of an optical integrated circuit device according to an embodiment of the inventive concept;

FIG. 2 is a cross-sectional view taken along line I-I′ of FIG. 1;

FIG. 3 is a graph showing optical transmittance of a signal waveguide according to voltage provided to the signal electrodes of FIG. 1;

FIG. 4 is a plan view illustrating an example of an optical system of an embodiment of the inventive concept;

FIG. 5 illustrates an example of an optical system according to another embodiment of the present disclosure;

FIG. 6 illustrates an example of an optical system according to another embodiment of the present disclosure; and

FIG. 7 illustrates an example of an optical system according to another embodiment of the present disclosure.

### DETAILED DESCRIPTION

Embodiments of the inventive concept will now be described in detail with reference to the accompanying drawings. Advantages and features of embodiments of the inventive concept, and methods for achieving the advantages and features will be apparent from the embodiments described in detail below with reference to the accompanying drawings. However, the inventive concept may be embodied in different forms and should not be construed as limited to the embodiments set forth herein. Rather, these embodiments are provided so that this disclosure will be thorough and complete, and will fully convey the scope of the inventive concept to those skilled in the art, and the inventive concept is only defined by the scope of the claims. Like reference numerals refer to like elements throughout.

The terminology used herein is not for delimiting the embodiments of the inventive concept but for describing the embodiments. The terms of a singular form may include plural forms unless otherwise specified. It will be further understood that the terms “includes”, “including”, “comprises”, and/or “comprising”, when used ‘in this description, specify the presence of stated elements, operations, and/or components, but do not preclude the presence or addition of one or more other elements, operations, and/or components. Furthermore, reference numerals, which are presented in the order of description, are provided according to the embodiments and are thus not necessarily limited to the order.

The embodiments of the inventive concept will be described with reference to example cross-sectional views and/or plan views. In the drawings, the dimensions of layers and regions are exaggerated for clarity of illustration. Therefore, the forms of the example drawings may be changed due to a manufacturing technology and/or error tolerance. Therefore, the embodiments of the inventive concept may involve changes of shapes depending on a manufacturing process, without being limited to the illustrated specific forms.

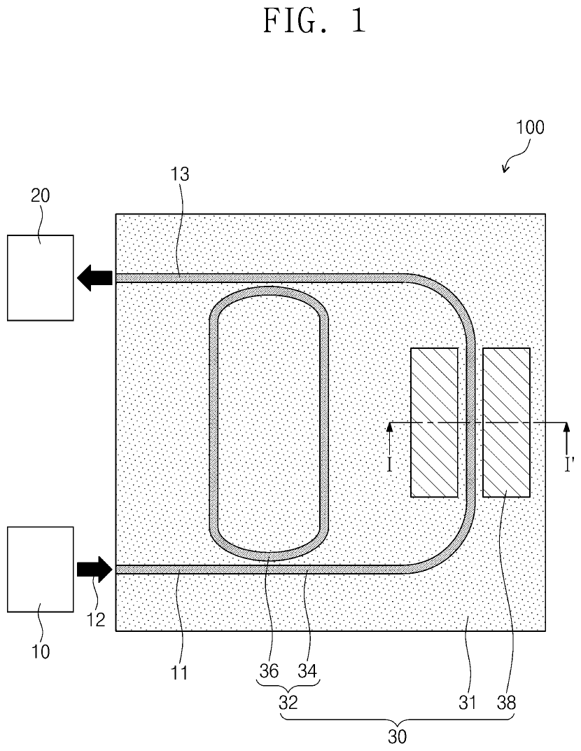

FIG. 1 illustrates an example of an optical system 100 according to the inventive concept.

Referring to FIG. 1, the optical system 100 of an embodiment of the inventive concept may include a quantum information and communication optical system. According to an example, the optical system 100 may include a light source 10, a photodetector 20, and an optical integrated circuit device 30.

The light source 10 may generate light 12 or an optical signal. The light 12 may include laser light. The light source 10 may include a laser device.

The photodetector 20 may receive the light 10 or an optical signal. The photodetector 20 may include a photodiode, but an embodiment of the inventive concept is not limited thereto. Although not illustrated, the photodetector 20 may be connected to a control unit.

The optical integrated circuit device 30 may be provided between the light source 10 and the photodetector 20. The optical integrated circuit device 30 may store or read photons using a self-interference resonance structure.

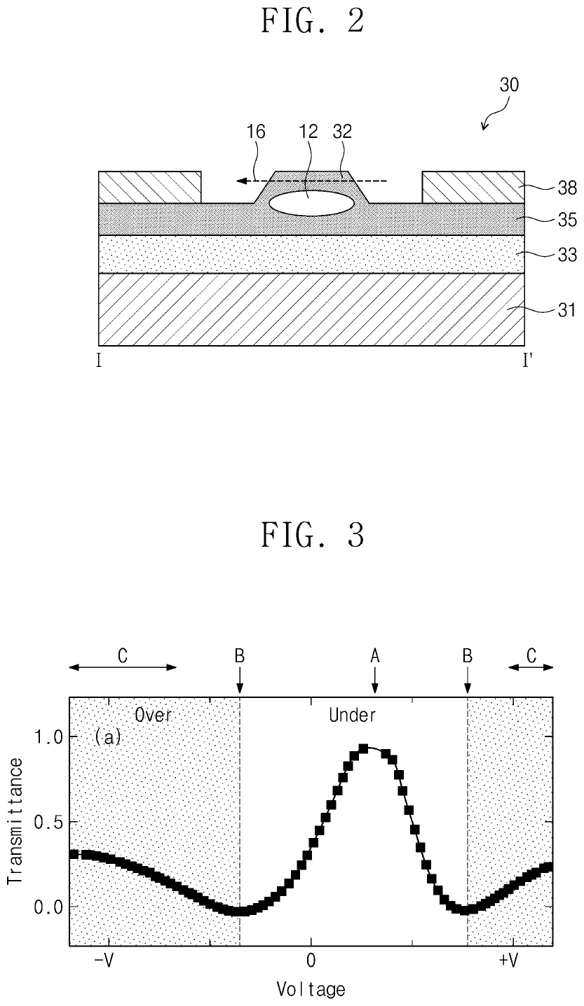

FIG. 2 is a cross-sectional view taken along line I-I′ of FIG. 1.

Referring to FIGS. 1 and 2, the optical integrated circuit device 30 may include a substrate 31, a buffer layer 33, an optical waveguide layer 35, and signal electrodes 38.

The substrate 31 may include a silicon substrate.

The buffer layer 33 may be provided on the substrate 31. The buffer layer 33 may include a silicon oxide.

The optical waveguide 35 may be provided on the buffer layer 33. The optical waveguide 35 may include a lithium niobate oxide (LiNbO₃). For example, the optical waveguide layer 35 may have an optical waveguide 32. The light 12 may propagate along the optical waveguide 32. The optical waveguide 32 may include a ridge waveguide. According to an example, the optical waveguide 32 may include a signal waveguide 34 and a resonant waveguide 36.

The signal waveguide 34 may have an input terminal 11 and an output terminal 13 on one side of the substrate 31. The signal waveguide 34 may be rounded on another side of the substrate 31. The signal waveguide 24 may transfer the light 12.

The resonant waveguide 36 may be provided adjacent to each of the input terminal 11 and the output terminal 13 of the signal waveguide 34. The resonant waveguide 36 may have a circular or elliptic shape in a plan view. The resonant waveguide 36 may store or output photons.

The signal electrodes 38 may be provided adjacent to both sides of the signal waveguide 34 on the other side of the substrate 31. The signal electrodes 38 may tune a coupling coefficient of the resonant waveguide 36 and the signal waveguide 34 using an electric field 16.

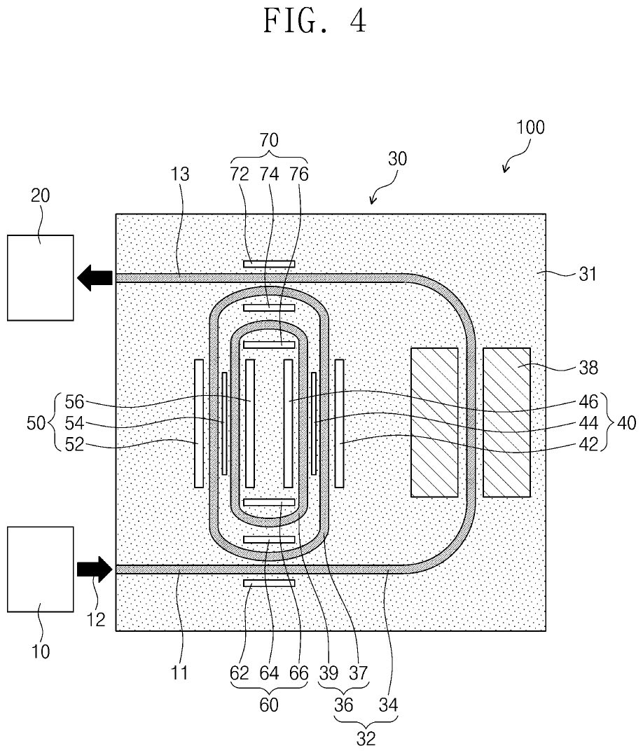

FIG. 3 shows optical transmittance of the signal waveguide 34 according to voltage provided to the signal electrodes 38.

Referring to FIG. 3, when there is no voltage between the signal electrodes 38 (point A), the light 12 may not be provided to the resonant waveguide 36 and may be output through the signal waveguide 34. There may be no coupling between the resonant waveguide 36 and the signal waveguide 34. When a critical voltage is applied between the signal electrodes 38, photons may be stored in the resonant waveguide 36 at point B (=critically coupled point at which transmittance is 0). When the transmittance decreases below the threshold voltage, photons may be stored in the resonant waveguide 36 for at least a certain time. When a voltage that is at least the threshold voltage is applied to the signal electrodes 38 (point C), the stored photons may be output to the output terminal 13 of the signal waveguide 34.

Therefore, the optical system 100 of an embodiment of the inventive concept may record and read information by storing or outputting photons in or from the resonant waveguide 36 using voltage provided to the signal electrodes 38.

FIG. 4 illustrates an example of the optical system 100 of an embodiment of the inventive concept.

Referring to FIG. 4, the resonant waveguide 36 of the optical integrated circuit device 30 may include a main resonant waveguide 37 and a minor resonant waveguide 39. The main resonant waveguide 37 may be provided adjacent to each of the input terminal 11 and the output terminal 13 of the signal waveguide 34. The main resonant waveguide 37 may store or output photons. The minor resonant waveguide 39 may be provided in the main resonant waveguide 37. The minor resonant waveguide 39 may additionally store or resonate photons in the main resonant waveguide 37.

According to an example, the optical integrated circuit device 30 may further include a first side resonant electrode 40, a second side resonant electrode 50, an input resonant electrode 60, and an output resonant electrode 70.

The first side resonant electrode 40 may be provided on one sides of the main resonant waveguide 37 and the minor resonant waveguide 39 in proximity to the signal electrodes 38. The first side resonant electrode 40 may additionally tune a coupling coefficient of the main resonant waveguide 37 and the signal waveguide 34. According to an example, the first side resonant electrode 40 may include a first external resonant electrode 42, a first middle resonant electrode 44, and a first internal resonant electrode 46. The first external resonant electrode 42 may be provided between the main resonant waveguide 37 and the signal electrodes 38. The first middle resonant electrode 44 may be provided between the main resonant waveguide 37 and the minor resonant waveguide 39. The first internal resonant electrode 46 may be provided in the minor resonant waveguide 39.

The second side resonant electrode 50 may be provided on other sides of the main resonant waveguide 37 and the minor resonant waveguide 39 in proximity to the input terminal 11 and the output terminal 13. The second side resonant electrode 50 may additionally tune the coupling coefficient of the main resonant waveguide 37 and the signal waveguide 34. According to an example, the second side resonant electrode 50 may include a second external resonant electrode 52, a second middle resonant electrode 54, and a second internal resonant electrode 56. The second external resonant electrode 52 may be provided on an outer periphery on the other side of the main resonant waveguide 37. The second middle resonant electrode 54 may be provided between the main resonant waveguide 37 and the minor resonant waveguide 39. The second internal resonant electrode 56 may be provided in the minor resonant waveguide 39.

The input resonant electrode 60 may be provided between the input terminal 11 of the signal waveguide 34 and the resonant waveguide 36. The input resonant electrode 60 may additionally tune a coupling coefficient of the input terminal 11 of the signal waveguide 34 and the main resonant waveguide 37. The input resonant electrode 60 may include an external input electrode 62, an intermediate input electrode 64, and an internal input electrode 66. The external input electrode 62 may be provided outside the input terminal 11 of the signal waveguide 34 and the main resonant waveguide 37. The intermediate input electrode 64 may be provided between the minor resonant waveguide 39 and the main resonant waveguide 37 adjacent to the input terminal 11 of the signal waveguide 34. The internal input electrode 66 may be provided in the minor resonant waveguide 39. The intermediate input electrode 64 may be narrower than the external input electrode 62 and the internal input electrode 66.

The output resonant electrode 70 may be provided between the output terminal 13 of the signal waveguide 34 and the resonant waveguide 36. The output resonant electrode 70 may additionally tune a coupling coefficient of the output terminal 13 of the signal waveguide 34 and the main resonant waveguide 37. The output resonant electrode 70 may include an external output electrode 72, an intermediate output electrode 74, and an internal output electrode 76. The external output electrode 72 may be provided outside the output terminal 13 of the signal waveguide 34 and the main resonant waveguide 37. The intermediate output electrode 74 may be provided between the minor resonant waveguide 39 and the main resonant waveguide 37 adjacent to the output terminal 13 of the signal waveguide 34. The internal output electrode 76 may be provided in the minor resonant waveguide 39. The intermediate output electrode 74 may be narrower than the external output electrode 72 and the internal output electrode 76.

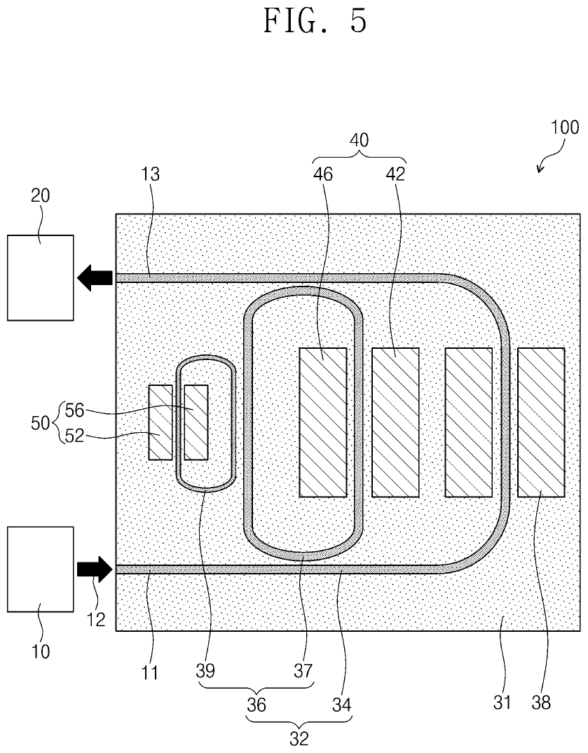

FIG. 5 illustrates an example of the optical system 100 according to the inventive concept.

Referring to FIG. 5, the minor resonant waveguide 39 of the optical system 100 of an embodiment of the inventive concept may be provided outside the main resonant waveguide 39. The minor resonant waveguide 39 may be provided adjacent to the light source 10, the input terminal 11, the output terminal 13, and the photodetector 20. The minor resonant waveguide 39 and the main resonant waveguide 37 each may have an annular shape in a plan view. The minor resonant waveguide 39 may be smaller than the main resonant waveguide 37.

The first external resonant electrode 42 and the first internal resonant electrode 46 of the first side resonant electrode 40 may be provided outside and inside the main resonant waveguide 37 adjacent to the signal electrodes 38. The first external resonant electrode 42 and the first internal resonant electrode 46 may tune the frequency of photons in the main resonant waveguide 37. When the frequency of photons to be stored does not match a resonance frequency of the main resonant waveguide 37, a bias voltage between the first external resonant electrode 42 and the first internal resonant electrode 46 may make the photon frequency match the resonance frequency of the main resonant waveguide 37.

The second external resonant electrode 52 and the second internal resonant electrode 56 of the second side resonant electrode 50 may be provided outside and inside the minor resonant waveguide 39. The second external resonant electrode 52 and the second internal resonant electrode 56 may finely tune the resonance frequency of the main resonant waveguide 37.

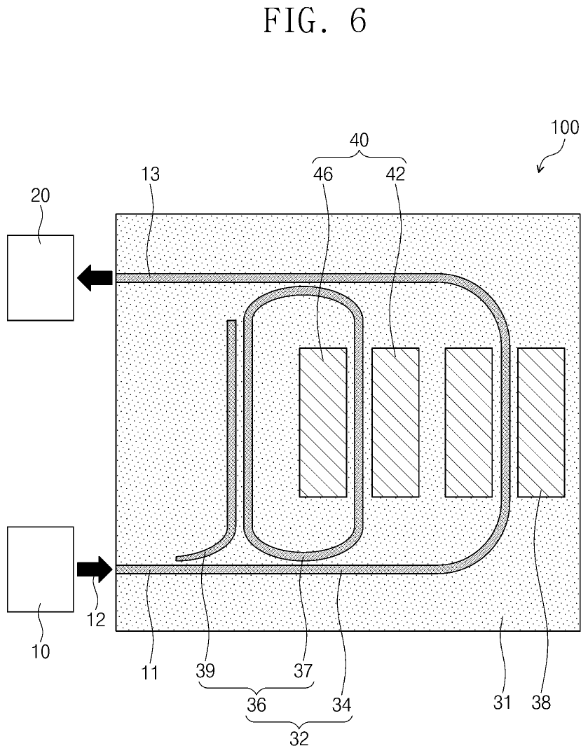

FIG. 6 illustrates an example of an optical system 100 according to the inventive concept.

Referring to FIG. 6, the minor resonant waveguide 39 of the optical system 100 of an embodiment of the inventive concept may be provided outside the main resonant waveguide 39 and may have a tapered structure. The minor resonant waveguide 39 may be provided adjacent to the light source 10, the input terminal 11, the output terminal 13, and the photodetector 20. The minor resonant waveguide 39 may be tapered in the vicinity of the input terminal 11. The minor resonant waveguide 39 may be shaped like J in a plan view. The minor resonant waveguide 39 may eliminate a higher-order mode from modes formed in the main resonant waveguide 37 so as to increase purity of the modes.

The light source 10, the photodetector 20, the signal waveguide 34, the main resonant waveguide 37, the signal electrode 38, and the first side resonant electrode 40 may be configured in the same manner as illustrated in FIG. 5.

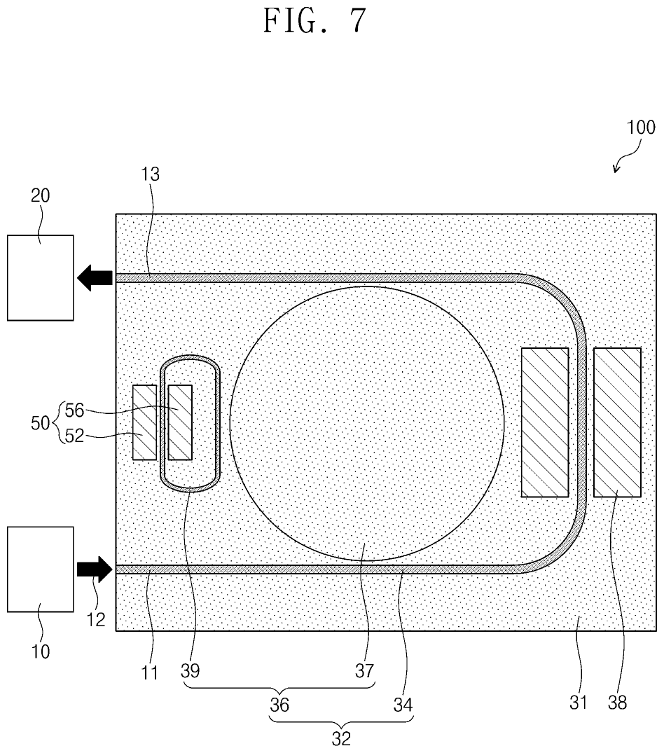

FIG. 7 illustrates an example of the optical system 100 according to the inventive concept.

Referring to FIG. 7, the main resonant waveguide 37 of the optical system 100 of an embodiment of the inventive concept may have a shape of a disc or plate. The disc-shaped main resonant waveguide 37 may have excellent loss characteristics compared to an annular race-track resonator.

The light source 10, the photodetector 20, the signal waveguide 34, the minor resonant waveguide 39, the signal electrode 38, the first side resonant electrode 40, and the second side resonant electrode 50 may be configured in the same manner as illustrated in FIG. 5.

As described above, the optical integrated circuit device according to an embodiment of the inventive concept may control a coupling coefficient of a resonant waveguide and a signal waveguide at high speed using voltage provided to electrodes on both sides of the signal waveguide in proximity to the resonant waveguide.

Although the embodiments of the present invention have been described, it is understood that the present invention should not be limited to these embodiments but various changes and modifications can be made by one ordinary skilled in the art within the spirit and scope of the present invention as hereinafter claimed.

What is claimed is:

1. An optical integrated circuit device comprising:
a substrate;
a buffer layer provided on the substrate;
an optical waveguide layer provided on the buffer layer and including a signal waveguide and a resonant waveguide adjacent to an input terminal and output terminal of the signal waveguide; and
a plurality of signal electrodes provided on one side of the resonant waveguide and on the optical waveguide layer of both sides of the signal waveguide.

2. The optical integrated circuit device of claim 1, wherein the optical waveguide layer includes a lithium niobate.

3. The optical integrated circuit device of claim 1, wherein the resonant waveguide includes:
a main resonant waveguide; and
a minor resonant waveguide in the main resonant waveguide.

4. The optical integrated circuit device of claim 3, further comprising first side resonant electrodes provided on one sides of the main resonant waveguide and the minor resonant waveguide.

5. The optical integrated circuit device of claim 4, wherein the first side resonant electrodes include:
a first external resonant electrode on an outer periphery of the main resonant waveguide; and
a first internal resonant electrode in the minor resonant waveguide.

6. The optical integrated circuit device of claim 5, wherein the first side resonant electrodes further include a first middle resonant electrode provided between the first external resonant electrode and the first internal resonant electrode and between the main resonant waveguide and the minor resonant waveguide.

7. The optical integrated circuit device of claim 3, further comprising second side resonant electrodes provided on other sides of the main resonant waveguide and the minor resonant waveguide.

8. The optical integrated circuit device of claim 7, wherein the second side resonant electrodes include:
a second external resonant electrode on an outer periphery of the main resonant waveguide; and
a second internal resonant electrode in the minor resonant waveguide.

9. The optical integrated circuit device of claim 8, wherein the second side resonant electrodes further include a second middle resonant electrode provided between the second external resonant electrode and the second internal resonant electrode and between the main resonant waveguide and the minor resonant waveguide.

10. The optical integrated circuit device of claim 3, further comprising:
an input resonant electrode provided adjacent to the input terminal and the resonant waveguide; and
an output resonant electrode provided adjacent to the output terminal and the resonant waveguide.

11. An optical system comprising:
a light source configured to generate light;
a photodetector configured to detect the light; and
an optical integrated circuit device provided between the light source and the photodetector,
wherein the optical integrated circuit device includes:
a substrate;
a buffer layer provided on the substrate;
an optical waveguide layer provided on the buffer layer and including a signal waveguide and a resonant waveguide adjacent to an input terminal and output terminal of the signal waveguide; and
a plurality of signal electrodes provided on one side of the resonant waveguide and on the optical waveguide layer of both sides of the signal waveguide.

12. The optical system of claim 11, wherein the resonant waveguide includes:
a main resonant waveguide; and
a minor resonant waveguide smaller the main resonant waveguide.

13. The optical system of claim 12, wherein the minor resonant waveguide is arranged outside the main resonant waveguide and provided adjacent to the input terminal and the output terminal.

14. The optical system of claim 12, wherein the minor resonant waveguide is shaped like J.

15. The optical system of claim 12, wherein the main resonant waveguide is shaped like a disc.

16. An optical integrated circuit device comprising:
a substrate;
a buffer layer provided on the substrate;
an optical waveguide layer provided on the buffer layer and including a signal waveguide and a resonant waveguide adjacent to an input terminal and output terminal of the signal waveguide; and
a plurality of signal electrodes provided on one side of the resonant waveguide and on the optical waveguide layer of both sides of the signal waveguide,
wherein the resonant waveguide includes:
a main resonant waveguide; and
a minor resonant waveguide provided outside the main resonant waveguide and smaller than the main resonant waveguide.

17. The optical integrated circuit device of claim 16, further comprising first side resonant electrodes provided outside and inside the main resonant waveguide adjacent to the signal electrodes.

18. The optical integrated circuit device of claim 16, further comprising second side resonant electrodes provided outside and inside the minor resonant waveguide adjacent to the input terminal and the output terminal.

19. The optical integrated circuit device of claim 16, wherein the minor resonant waveguide is shaped like J.

20. The optical integrated circuit device of claim 16, wherein the main resonant waveguide is shaped like a disc.
